(19) United States
(12) Patent Application Publication
(10) Pub. No.: US 2012/0118014 A1
(43) Pub. Date: May 17, 2012

(54) Ornamental Illuminating Bullet Necklace with Imbedded Functionality

(76) Inventors: Jason King, Desert Hot Springs, CA (US); Michelle King, Desert Hot Springs, CA (US)

(21) Appl. No.: 13/230,906

(22) Filed: Sep. 13, 2011

Related U.S. Application Data
(60) Provisional application No. 61/414,031, filed on Nov. 16, 2010.

(51) Int. Cl. A44C 25/00; A44C 15/00; G06F 1/16; A44C 5/00

(52) U.S. Cl. 63/1.13; 63/23; 63/3; 63/1.14; 361/679.03

(57) ABSTRACT

An ornamental necklace that projects an image or otherwise illuminates a particular design, while providing a user with imbedded electronic features to improve interoperability, interaction and user convenience. The necklace structure takes the form of a hollow bullet shell and round, on which may be provided an ornamental design that is luminescent. The luminosity is provided by glow paint, an LED light source or other similar light projecting means. Within the cavity of the bullet may comprise a plurality of electronic functions, such as an internal memory means, Bluetooth capability for interacting with other electronic devices, an imbedded microphone, or finally a simple storage compartment. An internal battery provides electrical power if an LED or an electrical light source is utilized. The purpose of the device is to provide an aesthetically pleasing accessory while providing imbedded electronic features to be utilized as desired.

### CROSS REFERENCE TO RELATED APPLICATION

This application claims the benefit of U.S. Provisional Application No. 61/414,031 filed on Nov. 16, 2010, entitled “Glow Bullet.”

### BACKGROUND OF THE INVENTION

1. Field of the Invention

The present invention relates to combination ornamental accessories and electronic devices. More specifically, the present invention relates to an illuminating, bullet-shaped pendant or necklace that may include a plurality of electronic features, depending upon embodiment. A graphical design or projection is provided that glows or illuminates as desired. Electrical power is derived from internal battery means within the cavity of the bullet-shape.

2. Description of the Prior Art

Ornamental jewelry and pendants are well known in the art. These items have familiar design and structural elements for providing an aesthetic accessory for a user. They may take the form of any ornamental shape, size, color or design to suit the user's preferences or to adorn a given outfit. The present invention discloses a combination article of jewelry and imbedded electronic function that provides an ornamental structure with inherent utility. The contemplated structure for the disclosed invention is a hollow bullet shell and round in necklace or pendant form. The interior of the bullet may provide housing for a specific electronic feature, while its design incorporates an illumination means for displaying, glowing or projecting a desired image from the surface of the housing.

Similarly described in the art are electronic devices and interactive technology therefor. The proliferation of wireless technology and interaction between electronic devices provides a market for items with interoperable communication means. These items provide improved functionality and usability compared to independent electronic devices. Devices such as these include wireless phones, remotes, Bluetooth devices and other electronic interactive devices that allow wireless control of or communication with another device. The size and capacity of such devices has improved dramatically, as advancing technology creates smaller devices with far more capability than predecessors. The present invention discloses an ornamental structure as previously described that incorporates an imbedded electronic capability. Also provided is an illumination means for displaying the aforementioned aesthetic design on the surface of the bullet or projecting the design therefrom.

Devices have been described in the art, as well as device published and patented. These items describe various pendants or jewelry, and further devices that combine these articles with electronic means. While they may fulfill a role and meet their respective requirements, there exists a need for a new article of jewelry that incorporates both an aesthetic quality and an electronic interface for interacting with third party devices. The devices in the art lack either the electronic functionality, or provide limited means therefor. Similarly, no devices in the art are described for such a device with a bullet structure with imbedded functionality.

Several design patents are described for ornamental qualities of a bullet shaped structure, but without utility or imbedded features. U.S. Design Patent D433,581 to Williams discloses a bullet shaped spoke weight, U.S. Design Patent D460,398 to Berry discloses an ornamental design for a bullet shaped wheel fastener, and finally U.S. Design Patent D500,953 to Moore discloses an ornamental design for a bullet shaped container.

Utility patents have been disclosed that combine features of both a jewelry item and an imbedded electronic or illuminating feature. U.S. Pat. No. 4,262,324 to Murphy discloses a necklace pendant in combination with illuminated jewelry. The necklace is an elongate electrical conductor with a dry cell battery in series with the same. The pendant is a miniature lighting fixture which receives electrical current through the necklace conductor for illumination thereof. While the Murphy patent describes an illuminating pendant with a unique power delivery means, it does not describe one that is bullet-shaped or include electronic periphery interaction or storage therein.

U.S. Pat. No. 4,096,552 to Ben-Porat describes an article of jewelry such as a necklace and pendant, wherein the pendant includes an ornamental case with a dry cell battery, switch and incandescent lamps therein. The light flashes to produce a psychedelic effect for the user and surrounding individuals when in use. Similar to the Murphy patent, this device discloses illuminating jewelry, but not one that is bullet-shaped or containing the same electronic features as the present invention. While the present invention may provide a psychedelic effect if desired via its illuminated design or projection, it is not its primary purpose or intent

U.S. Pat. No. 7,318,328 to Kamara discloses a necklace or bracelet with a luminous medallion. A clasp houses a removable battery and powers an internally embedded LED. No mention is made of a specific structure for the necklace or bracelet that includes a bullet shape, while its functionality if far more limited than that of the present invention.

U.S. Pat. No. 6,954,659 to Tushinsky describes a fashion accessory adapted to coordinate with a wireless device and provide an alert therefor. The accessory may take the form of a bracelet, pendant, necklace or brooch. Electric circuits imbedded within the accessory, along with an antenna, communicate with another wireless device for providing an alerting accessory module. The device works wirelessly and alerts the user when in a close proximity thereto. This device is suitable for use with an electronic device as an alert; however no mention is made beyond an alert function. The present invention provides communication means with electronic devices, may act as a data storage device itself, may provide control therefor, or simply provide an open cavity for storage of material therein, depending upon embodiment.

The disclosed article of jewelry includes an illuminated design along its exterior surface, taking the form of a cross or similar ornamental design. The illumination may be provided by an imbedded LED light source, glow paint or similar light source that allows vision in low light conditions. The embodiments of the bullet shaped structure include a hollow inner space for storage of a computer data storage device, a Bluetooth capability with an external on/off button, an imbedded microphone to act as a cell phone or video game peripheral device, or finally an open storage without imbedded electronics. Its structure and design substantially diverges in design elements from the prior art, consequently it is clear that there is a need in the art for an improvement to existing articles of jewelry that provides imbedded electronic functionality and devices that illuminate an graphical or ornamental design. In this regard the instant invention substantially fulfills these needs.

### SUMMARY OF THE INVENTION

In view of the foregoing disadvantages inherent in the known types of jewelry articles now present in the prior art, the present invention provides a new jewelry article wherein the same can be utilized for providing convenience for the user when adorning an ornamental bullet shaped pendant with imbedded electronic features for improved communication with third party devices, and one that provides an illumination means for graphically displaying an visual design on the outer surface of the structure.

It is therefore an object of the present invention to provide a new and improved jewelry article that has all of the advantages of the prior art and none of the disadvantages.

It is therefore an object of the present invention to provide an ornamental jewelry article that includes an illuminated design on its outer surface. The illuminated design is provided by a projecting light source, such as an LED, or is painted on using phosphorescent glow paint that visible at night and in low light situations.

Another object of the present invention is to provide an ornamental jewelry article that takes the form of a bullet shape structure, with a bullet round and casing attached to a necklace, bracelet or similar attachment means to allow the structure to form a pendant.

Another object of the present invention is to provide a combination device that includes the aforementioned ornamental qualities, while providing an imbedded electronic functionality. The functionality may take several forms, including an imbedded computer memory device, a Bluetooth device for communicating with external electronic devices, or finally an imbedded microphone device.

Yet another object of the present invention is to provide an ornamental, bullet shaped jewelry article with a hollow interior for storage, containment of internal electronics or securement of an internal battery means for powering the illumination means and electronic devices therein.

Other objects, features and advantages of the present invention will become apparent from the following detailed description taken in conjunction with the accompanying drawings.

### BRIEF DESCRIPTIONS OF THE DRAWINGS

FIG. 1 shows a frontal perspective view of the present invention, wherein a bullet shaped pendant is provided in necklace form, and the ornamental design is highlighted on the outer surface of the pendant.

### DETAILED DESCRIPTION OF THE INVENTION

Although the characteristic features of this invention will be particularly pointed out in the claims, the invention itself and manner in which it may be made and used may be better understood after a review of the following description, taken in connection with the accompanying drawings wherein like numeral annotations are provided throughout.

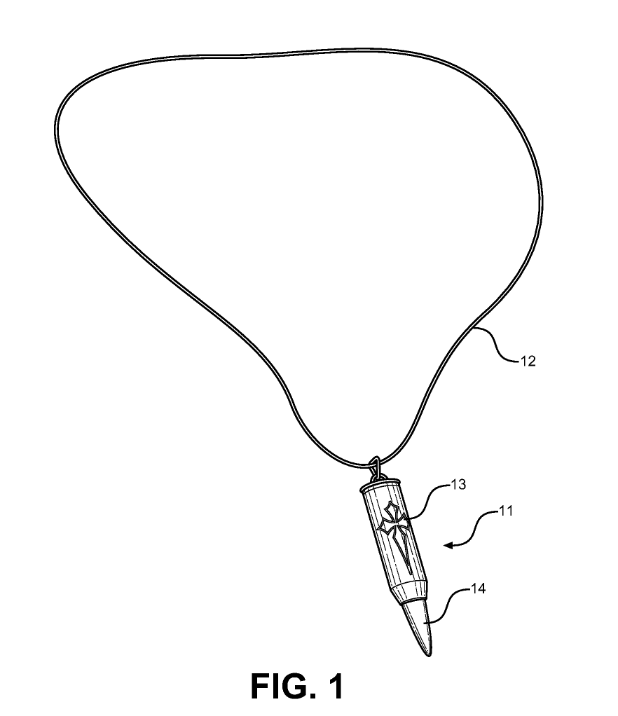

Referring now to FIG. 1, there is shown a front perspective view of a bullet shaped necklace pendant 11 with an embodiment of the ornamental design 13 provided thereon. The pendant 11 comprises a bullet casing and round 14, which may be affixable to any typical jewelry attachment means known to those skilled in the art of jewelry articles. In the preferred embodiment, the pendant 11 is provided on a necklace 12 for placement around a user's neck. Alternative embodiments may include a bracelet attachment, anklet attachment or similar bodily attachment means.

The ornamental design 13 on the pendant 11 may take any shape desired by the user, including a cross, a lightning pattern, a piece sign or any other ornamental shape. The construction of the design 13 may take of the form of a painted symbol, in which phosphorescent glow paint may be utilized for visualization in low light conditions, or likewise the design may include a window from which an LED light is projected through. In the latter form, the pattern may be projected from the pendant 11 onto a surface for further visualization thereof. In either embodiment, the pattern is easily recognizable in a dark environment.

The structure of the pendant 11 provides a hollow internal cavity, within which may be provided a number of features or functions. In its simplest form, the hollow cavity is provided as a storage compartment for the user, accessible via the bullet 14 that is screw into or hingeable from the casing body. For use with an LED light projection means, the internal cavity provides housing for a battery power source, the LED and any necessary electrical components for operating the same.

In exemplary embodiments of the present invention, the cavity of the casing provides housing for electronic features that are used to interact with the user and with third party electronics. The first preferred electronic embodiment provides an internal memory stick or data storage means, which is cooperative with a personal computer via USB or micro-USB attachment structure. A port may be provided for attachment of a USB cord, or likewise a USB connector may be provided on the pendant 11 itself. This provides the user with the ability to utilize the pendant 11 for both its ornamental qualities as an article of jewelry, while providing easy access and transport of a memory storage means, useful for moving large amounts of data from one computer to another or for storing data. In this form, a battery means may be provided only if an LED light source is also provided. The combination memory stick with a painted ornamental design 13 requires no internal battery, as the USB connection to the computer provides necessary power. Alternatively, the USB connection may power an LED that only illuminates in connection with a computer, wherein power is being directly supplied therefrom.

In a second electronic embodiment of the present invention, the device may include imbedded open wireless capability for tethering to external electronic devices. The wireless capability may include Bluetooth technology or similar architecture, which allows interaction of the device with other electronic devices. Once tethered, the wireless connection may serve as a means to transfer data to and from the device, a means to turn on and off a device remotely, or finally act as a microphone for a cellular device, similar to a headset. Any electronic circuits or antennas required to complete this wireless connectivity task are imbedded within the cavity of the pendant 11 shell, while the bullet 14 itself or a raised ornamental design 13 may serve as a button for providing input control for the wireless connection. Once connected, an imbedded LED may serve to illuminate the button/ornamental design 13 on the pendant 11 to show activity and connectivity.

In use, the present invention serves as a unique accessory for a user, providing ornamental features that one may find attractive, while also provided functionality in the form of an electronic device or wireless connectivity device. Several embodiments are contemplated for the construction of the device, from its simplest form as a hollow bullet with a phosphorescent painted design, to one that is illuminated by an internal LED and may act as an electronic data storage or wireless controller for third party electronic devices. Its construction may vary depending upon chosen components to operate the different embodiments. It is not desired to limit the design of the ornamental features to just that shown in the figure, but to provide an embodiment contemplated for completing the disclosed tasks and functions.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An ornamental pendant, comprising:
a hollow structure with a likeness of a bullet and associated bullet casing, an inner cavity and an attachment means;
said bullet is removably attached to said casing for access to said inner cavity;
an illuminated design on said casing.

2) A device as in claim 1, wherein said illuminated design is a painted design comprising of a phosphorescent paint that is visible in low light environments.

3) A device as in claim 1, wherein:
said illuminated design comprises a transparent window;
and said hollow structure further comprises an illuminating LED for projecting light through said window,
a battery power means and associated LED electronics with said inner cavity.

4) A device as in claim 1, wherein said structure attachment means comprises a cord that may function as a necklace, bracelet or anklet.

5) A device as in claim 1, wherein said bullet is removably attached via screw means.

6) A device as in claim 1, wherein said bullet is removably attached via a hinge attachment means between said bullet and said casing.

7) A combination ornamental pendant and computer data storage device, comprising:
a hollow structure with a likeness of a bullet and associated bullet casing, an inner cavity and an attachment means;
an illuminated design on said casing;
an internal digital data storage means secured within said inner cavity;
a connectivity means for attaching said storage means to a personal computer.

8) A device as in claim 7, wherein said internal digital data storage means comprises a flash memory data storage device for storing digital data.

9) A device as in claim 7, wherein said connectivity means comprises a micro-USB port for attachment of a USB wire and connection to a personal computer therewith.

10) A device as in claim 7, wherein said connectivity means comprises a USB connector for attachment to a personal computer.

11) A device as in claim 7, wherein:
said illuminated design comprises a transparent window;
and said hollow structure further comprises an illuminating LED for projecting light through said window,
and associated LED electronics with said inner cavity and power derived through said connectivity means.

12) A device as in claim 7, wherein said illuminated design is a painted design comprising of a phosphorescent paint that is visible in low light environments.

13) A device as in claim 7, wherein said structure attachment means comprises a cord that may function as a necklace, bracelet or anklet.

14) A combination ornamental pendant and wireless connectivity device, comprising:
a hollow structure with a likeness of a bullet and associated bullet casing, an inner cavity and an attachment means;
an illuminated design on said casing;
a battery power means within said inner cavity;
a wireless connectivity means within said inner cavity for communicating with third party electronic devices, powered by said batter power means.

15) A device as in claim 14, wherein said wireless connectivity comprises Bluetooth open wireless technology for wirelessly exchanging data.

16) A device as in claim 14, further comprising a microphone for recording or transferring a user's voice or noises through said wireless connectivity means to a third party electronic device.

17) A device as in claim 14, wherein said bullet further comprises a depressible button for controlling said wireless connectivity means.

18) A device as in claim 14, wherein:
said illuminated design comprises a transparent window;
and said hollow structure further comprises an illuminating LED for projecting light through said window,
and associated LED electronics with said inner cavity and power derived through said battery power means.

19) A device as in claim 14, wherein said illuminated design is a painted design comprising of a phosphorescent paint that is visible in low light environments.

20) A device as in claim 14, wherein said structure attachment means comprises a cord that may function as a necklace, bracelet or anklet.
